(19) United States
(12) Patent Application Publication
(10) Pub. No.: US 2018/0273680 A1
(43) Pub. Date: Sep. 27, 2018

(54) DYEABLE SYNTHETIC FIBER

(71) Applicant: Parkdale, Incorporated, Gastonia, NC (US)

(72) Inventor: Robert Alton Usher, JR., Charlotte, NC (US)

(73) Assignee: Parkdale, Incorporated, Gastonia, NC (US)

(21) Appl. No.: 15/994,120

(22) Filed: May 31, 2018

Related U.S. Application Data
(62) Division of application No. 14/667,027, filed on Mar. 24, 2015.
(60) Provisional application No. 61/970,569, filed on Mar. 26, 2014.

(51) Int. Cl. C08G 63/16; B29C 47/00; B29L 31/00; B29K 67/00

(52) U.S. Cl. CPC C08G 63/16; B29K 2067/00; B29L 2031/731; B29C 47/0014

(57) ABSTRACT

A dyed blended yarn is disclosed that includes cotton fibers, polyester fibers, and a dye selected from the group consisting of direct dyes and reactive dyes. The polyester fibers consist essentially of between about 9 and 16 mole percent of DEG based on the amount of polyester, between about 3.5 and 7 mole percent of adipic acid based on the amount of polyester, and between about 200 and 2000 ppm by weight pentaerythritol based on the amount of polyester. The blended yarn includes a dye selected from the group consisting of direct dyes and reactive dyes.

### RELATED APPLICATIONS

This application is a divisional application of Ser. No. 14/667,027 filed Mar. 24, 2015 for Dyeable Synthetic Fiber.

### BACKGROUND

The present invention relates to the manufacture of synthetic fibers, and more particularly to method for producing polymer fibers dyeable with reactive dyes.

Processes are well known for preparing polyester resin by a polymerization reaction of terephthalic acid and ethylene glycol in the presence of a catalyst. This resin can be extruded and drawn into fibers, and subsequently spun into yarns.

Such yarns are often blended with natural (i.e. cellulosic) fiber yarns, such as cotton, to produce fabrics having desirable characteristics in terms of strength, feel, etc.

In most cases the fabrics need to be dyed to produce a desired overall color and/or pattern for the finished product. Cotton yarns are typically dyed using a direct or reactive dye chemistry at atmospheric pressures and relatively low temperatures. These dyes typically produce little to no coloration in the polyester yarns in the same piece of material. Therefore, polyester yarns are typically dyed using a disperse dye chemistry in a process taking place at elevated temperatures and pressures.

The need to subject blended fabric to two completely separate dyeing processes requires extra time, equipment, energy, and expense.

Therefore, it would be desirable to produce blended fabrics which can be dyed using a single process using direct or reactive dyes.

### SUMMARY

This need is addressed by the present invention, which provides a polymer fiber dyeable with a reactive dye.

According to one aspect of the invention, a polyester fiber includes high levels of both DEG and adipic acid, so as to be dyeable with direct or reactive dyes.

According to another aspect of the invention, a method of making polyester fiber includes: subjecting a starting mixture of diethylene glycol (“DEG”), terephthalic acid (“TA”) or dim ethyl terephthalate (“DMT”), and a large amount of adipic acid to a polymerization reaction, so as to produce a polyester compound; and melting the polyester compound into a viscous liquid, extruding it, and drawing it into polyester fiber.

### DETAILED DESCRIPTION

The present invention comprises forming a thermoplastic copolymer from a mixture consisting essentially of terephthalic acid (“TA”) or dimethyl terephthalate (“DMT”), diethylene glycol (“DEG”), adipic acid, and a chain branching agent such as pentaerythritol.

One known process for producing conventional polyesters such as polyethylene terephthalate (“PET”) is esterification followed by condensation of a starting mixture consisting essentially of terephthalic acid (“TA”) or dimethyl terephthalate (“DMT”), ethylene glycol (as monoethylene glycol or “MEG”), and optionally a catalyst. The process may be done as a batch or continuous process. According to principles of the present invention, the starting mixture of the prior art process is modified by substitution of diethylene glycol (“DEG”) for MEG and inclusion of a large amount of adipic acid, well beyond commonly-accepted amounts. This results in an end product with significantly increased levels of DEG.

With DEG and adipic acid in significant quantities, the resulting end product is dyeable with direct or reactive dyes of the types more typically associated with natural fibers. While it is known that increased levels of DEG and/or addition of adipic acid improve dye uptake in polyester fibers, this refers to conventional disperse dyes. The present invention increases the level of both components far in excess of known levels in polyester. Furthermore, the inventor has found that presence of high levels of both DEG and adipic acid have a synergistic effect, producing a level of dye uptake not observed with either component alone.

Increased DEG levels and/or addition of adipic acid to fiber is known to reduce their tensile strength. However, this is not a detriment when fibers and resultant yarns are woven into blended fabrics along with cotton yarns, as the physical properties of the modified fiber more closely match those of the cotton yarns. Furthermore, reduction in strength of the polyester yarns is believed to reduce the incidence of “pilling,” as loose fibers ends in a piece of fabric are more likely to break off instead of forming a pill.

Generally, when the final composition of the polymer includes about 6 mol % DEG (in combination with adipic acid in the amounts described below), visible uptake of reactive dyes starts to be observed. For acceptable dyeing results in practical use, it is believed that the final composition should include at least about 9 mol % DEG. Increasing amounts of DEG in the composition are expected to further increase dye uptake, with about 16 mol % DEG being an upper limit based on the physics of the polymerization reaction. Testing has confirmed commercially-acceptable dyeing results at 12 mol % DEG. This is in contrast to prior art polyester typically incorporating DEG at about 1 mol % to 2 mol %.

Generally, the final composition should also include adipic acid at about 3.5 mol % to about 7 mol %. Testing has confirmed commercially-acceptable dyeing results at about 4-5 mol % adipic acid. This is in contrast to prior art polyester typically incorporating adipic acid at about 0.5 mol % to 1.5 mol %.

### EXAMPLE

For a nominal batch of 45.4 kg (100 lb.) of polyester fiber, the following inputs were provided: 38.6 kg (85 lb.) of TA, 13.7-15.9 kg (30-35 lb.) of DEG, and pentaerythritol in an amount in the range of 200 parts per million (“ppm”) to 2000 ppm. The mixture was reacted in a conventional polymerization reaction to produce solid pellets of polymer. Analysis showed the final material had an approximate composition of, in mol %: 80 TA, 12 DEG, 5 adipic acid, and 3 EG.

The polymerization reaction, being a condensation reaction, will produce both polymer and glycol monomers mixed with water. It is therefore necessary to provide excess DEG as part of the starting mixture to achieve the desired level of DEG in the PET. The exact amount of DEG needed to produce a specific DEG concentration in the finished product may be determined through a nominal amount of trial and error.

The polymer pellets were then melted into a viscous liquid and extruded and drawn into fibers, using conventional equipment and methods. For good fiber-making results, the intrinsic viscosity (“IV”) of the polymer resin should be in the range of 0.450-0.750. Preferably for best fiber-making results, the IV is in the range of 0.630-0.640. Adipic acid tends to greatly reduce viscosity of the melt. To counteract this effect, the IV may be manipulated by selection of the amount of chain-branching agent added. For example, when using pentaerythritol as described above, amounts in the higher end of the stated range will result in raising the melt viscosity to a commercially viable level.

The fibers were then spun into yarns, again using conventional equipment and processes. The finished yarns were subsequently woven into fabric.

The fabric was dyed using conventional reactive dye as used for natural fibers. Dye uptake was dramatically increased as compared to yarns made from unmodified PET, and color depth was acceptable for commercial use. Yarns made from the polymer fiber described herein are thus suitable for use in blended fabrics alongside cotton yarns. The blended fabric can be dyed in a single bath of reactive dye, greatly reducing the cost and complexity that would normally be required for dyeing blended fabrics.

The foregoing has described a new polymer and fiber design and a method for its production. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends any novel one, or any novel combination, of the features disclosed in this specification (including any accompanying claims, abstract and drawings), or to any novel one, or any novel combination, of the steps of any method or process so disclosed.

1. A dyed blended yarn consisting essentially of:
cotton fibers;
polyester fibers; and
a dye selected from the group consisting of direct dyes and reactive dyes;
in which the polyester fibers consist essentially of,
between about 9 and 16 mole percent of DEG based on the amount of polyester;
between about 3.5 and 7 mole percent of adipic acid based on the amount of polyester;
between about 200 and 2000 ppm by weight pentaerythritol based on the amount of polyester; and
a dye selected from the group consisting of direct dyes and reactive dyes.

2. A fabric formed from the dyed blended yarn of claim 1.

3. A fabric formed from the dyed blended yarn of claim 1 and selected from the group consisting of knitted fabrics and woven fabrics.

4. A fabric formed from the dyed blended yarn of claim 1 wherein said polyester has an intrinsic viscosity of between 0.450 and 0.750 deciliters per gram based on an intrinsic viscosity measurement method selected from the group consisting of ASTM method D4603, ASTM method D5225, and ISO 1628-5.

5. A fabric according to claim 4 wherein said intrinsic viscosity is between 0.630 and 0.640 deciliters per gram.

6. A dyed blended yarn According to claim 1 wherein said polyester is a long-chain synthetic polymer composed of at least 85% by weight of an ester of a dihydric alcohol and terephthalic acid.
